(19) United States
(12) Patent Application Publication
(10) Pub. No.: US 2013/0340721 A1
(43) Pub. Date: Dec. 26, 2013

(54) ABNORMALITY DETECTION APPARATUS FOR A FUEL SUPPLY SYSTEM

(71) Applicant: Toru Suda, Toyota-shi (JP)

(72) Inventor: Toru Suda, Toyota-shi (JP)

(73) Assignee: TOYOTA JIDOSHA KABUSHIKI KAISHA, Toyota-shi Aichi-ken (JP)

(21) Appl. No.: 14/004,587

(22) PCT Filed: Mar. 14, 2011
(86) PCT No.: PCT/JP2011/001465

§ 371 Date: Sep. 11, 2013

(51) Int. Cl. F02M 39/02

(52) U.S. Cl. CPC F02M 39/02
USPC 123/496

(57) ABSTRACT

Provided is an abnormality detection apparatus for a fuel supply system that can reliably detect an abnormality of the fuel pressure changing operation of the fuel supply system, comprising a fuel pump unit (11) to supply a fuel to an injector (3), a pressure regulator (20) capable of regulating a pressure of the fuel to a desired one set pressure and a set pressure changing operation mechanism (40) to change the set pressure, a state change detection section (51a) to change the set pressure to a high set pressure in response to a fuel supply amount to the injector (3) being substantially constant and to detect a variation of an energization state of the pump drive motor (11m) after changing the set pressure, and an abnormality determination section (51b) to determine whether or not there is an abnormality occurred in changing the set pressure.

### TECHNICAL FIELD

The present invention relates to an abnormality detection apparatus for a fuel supply system, and more particularly to an abnormality detection apparatus for a fuel supply system suitable for detecting abnormalities for changing operations in a fuel supply system capable of changing pressures of fuel to be supplied to an internal combustion engine by a fuel pump.

### BACKGROUND ART

In recent years, a vehicle such as an automotive vehicle having a power source constituted by an internal combustion engine has an on-board diagnosis system (hereinafter simply referred to as “OBD”) function to be performed by an electronic control unit (hereinafter simply referred to as “ECU”) for controlling the internal combustion engine The OBD partly has come to be required always diagnosing whether or not the exhaust gas emission is in the state in which the exhaust gas can be suppressed or not within a law regulation range during the operation of the internal combustion engine, and lighting a malfunction informing lamp (hereinafter simply referred to as “MIL”) when are generated abnormalities such as malfunctions to have the exhaust gas emission brought out of the law regulation range.

The internal combustion engine of this kind to be mounted on the vehicle is required to control a fuel injection amount in an extremely minute and accurate manner in a wide range of injection amount from a small amount of fuel injection amount to a large amount of injection amount to suppress the exhaust gas emission to a minimum level while responding to an operation input request from a driver and to respond a high fuel consumption reduction request. Furthermore, the abnormalities to be brought out of law regulation range of the exhaust gas emission are required to be rapidly and reliably detected with the aid of the OBD function of the ECU.

In view of the above problems, there have so far been developed a fuel supply system which are adapted to enable the pressure of fuel (hereinafter simply referred to as a “fuel pressure”) to be supplied to the internal combustion engine to be changed to an arbitrary one fuel pressure from among a plurality of different fuel pressures, and a wide variety of abnormality detection apparatuses which can detect abnormalities in the fuel supply system.

For example, conventionally known is an abnormality detection apparatus which can perform a malfunction determination for a fuel pressure control system in accordance with the relationship between a detection value of a fuel pressure sensor for detecting fuel pressure and a drive duty value of a variable pressure regulator for adjusting the fuel pressure. The above abnormality detection apparatus is operative to start a fuel pressure feedback control when the output value of the fuel pressure sensor reaches a dangerous fuel pressure below the lower limit line or above the upper limit of a malfunction determination dead zone, and to perform the determination of the malfunction of the fuel control system when the state having the output value of the fuel pressure sensor reach the dangerous fuel pressure continues for more than a predetermined time interval, and when the variation speed of the fuel pressure (fuel pressure variation width per a predetermined unit time) and the integral value of fuel pressure deviation to a target fuel pressure exceed predetermined values under the condition that the fuel pressure feedback control is being performed (for example see. Patent Document 1).

Another conventionally known abnormality detection apparatus is operative to detect an exhaust air-fuel ratio by an air-fuel ratio sensor after the discharge amount of the fuel pump is changed to a large flow amount from a small flow amount and to determine that the malfunction is generated in a changing mechanism for changing the discharge amount of the fuel pump when the detected value is not varied toward a rich side from a predetermined value (for example see Patent Document 2).

Still another conventionally known abnormality detection apparatus is operative to detect the closing state of a pressure regulator for adjusting fuel pressure by a valve contact switch, and to detect an abnormality state in accordance with the detection information of the valve contact switch when the fuel pump is deteriorated, resulting in causing an abnormality state in which the regulator valve continues to be closed with the fuel discharge pressure being below a predetermined value (for example see Patent Document 3).

The other conventionally known abnormality detection apparatuses include an apparatus which is adapted to determine that the fuel pump is in an abnormal state when the fuel pump continues to be operated for a predetermined time interval with the energization duty of the fuel pump being above a set duty value and with the actual energization electric current of the fuel pump being decreased to an allowable error smaller than a set electric current (for example see Patent Document 4), an apparatus which is adapted to determine that there is generated an abnormality in the fuel system other than the fuel pump, such as for example fuel pipes, fuel flow control members and the like when the air-fuel ratio is abnormally high and the rotational speed of the fuel pump drive motor is determined to be in the normal state (for example see Patent Document 5), an apparatus which is adapted to determine whether or not the electric current flowing in the fuel pump drive motor and the rotational speed of the fuel pump drive motor is within a suitable normal range in accordance with a designated electric current-rotation speed data map, and to detect an out-of-suitable range when the load and the rotational speed of the fuel pump drive motor is brought out of the suitable range due to the clogging of the pipe and the leakage of the pipe (for example see Patent Document 6), and an apparatus which is adapted to detect the drive electric current and the drive voltage of the fuel pump drive motor to calculate fuel discharge pressure and fuel discharge amount, and to diagnose the operation state of the fuel supply system (for example see Patent Document 7).

### CITATION LIST

### Patent Literature

Patent Document 1: Japanese Patent Application Publication No. H11-190240

Patent Document 2: Japanese Patent Application Publication No. H07-119572

Patent Document 3: Japanese Patent Application Publication No. H06-010744

Patent Document 4: Japanese Patent Application Publication No. 2008-038718

Patent Document 5: Japanese Patent Application Publication No. 2008-121594

Patent Document 6: Japanese Patent Application Publication No. 2004-162529

Patent Document 7: Japanese Patent Application Publication No. 2007-192198

### SUMMARY OF INVENTION

### Technical Problem

The previously mentioned conventional abnormality detection apparatus for a fuel supply system for the type using the fuel pressure sensor, however, encounters such a problem that the abnormality detection apparatus becomes expensive due to the fuel pressure sensor being costly.

In addition, the conventional abnormality detection apparatus for a fuel supply system for the type using the currently existing air-fuel ratio sensor, however, encounters such a problem that the air-fuel ratio sensor has a detection element which requires heat and warm-up, thereby making it impossible to detect abnormalities even if the concentration of unburned gas, i.e., HC becomes high at the cold starting time of the engine.

Furthermore, the conventional abnormality detection apparatus for a fuel supply system for the type has not been suitable for detecting the abnormalities of the fuel pressure changing operation in the fuel supply system which can change the fuel pressure to the internal combustion engine to an arbitrary fuel pressure from among a plurality of fuel pressures different from one another. For this reason, for example when the operation of the engine continues with the fuel pressure unchanged even if the fuel pressure changing valves and the like are malfunctioned, resulting from foreign objects entering the fuel during the travelling of the vehicle, the operation of the engine is finished with the state in which the abnormalities cannot be detected, thereby giving rise to a possibility that the abnormalities cannot be detected after the engine is restarted.

As will be understood from the foregoing description, the conventional abnormality detection apparatus for a fuel supply system encounters such problems as being difficult in reliably detecting abnormalities for the fuel pressure changing operation in the fuel supply system with the fuel pressure being changeable or otherwise leading the abnormality detection apparatus to a high cost.

It is therefore an object of the present invention to provide an abnormality detection apparatus for a fuel supply system which can reliably detect the abnormalities of the fuel pressure changing operation in the fuel supply system with the fuel pressure being changeable at a relatively low cost.

### Solution to Problem

To achieve the previously mentioned object of the present invention, the abnormality detection apparatus for a fuel supply system according to the present invention, (1) where the supply system comprises a fuel pump unit driven by a pump drive motor to supply fuel to a fuel consumption unit, a variable fuel pressure adjustment valve that introduces the fuel to be supplied to the fuel consumption unit from the fuel pump unit and is capable of adjusting to any optional one of set pressures selected from among a plurality of set pressures different in pressure from one another, and an operation unit that operates the variable fuel pressure adjustment valve to change the one optional one of set pressures to the other one set pressure selected from among the plurality of set pressures, the abnormality detection apparatus comprises a state change detection unit that operates the operation unit to change the set pressure of the variable fuel pressure adjustment valve from a first set pressure in the plurality of set pressures to a second set pressure in the plurality of set pressures when the fuel supply amount per unit time to be supplied to the fuel consumption unit is maintained substantially constant, and that detects the states varied in response to an energization of the pump drive motor after the set pressure is changed, and an abnormality determination unit that determines whether or not the change of the set pressure of the variable fuel pressure adjustment valve is in an abnormality state on the basis of a detection information detected by the state change detection unit.

By the construction as described above, the amount of fuel supplied to the fuel consumption unit is substantially constant, so that the set pressure of the variable fuel pressure adjustment valve is changed to the first set pressure from the second set pressure, with the result that the variation of the energization of the pump drive motor after changing the fuel pressure is detected by the state change detection unit, thereby making it possible for the abnormality determination unit to determine whether or not there is an abnormality occurred in the changing of the fuel pressure (set pressure) by the variable fuel pressure adjustment valve based on the detection information of the state change detection unit. Therefore, the abnormality detection apparatus for a fuel supply system according to the present invention can reliably detect abnormality of fuel pressure changing operation without using an expensive pressure sensor or the detection result of the air fuel sensor. Here, a variation of the energization state of the pump drive motor may be a variation in electric current in the pump drive motor, a variation of voltage at the terminal of the pump drive motor, or a variation indirectly detected as a variation in the operation state of the pump drive motor accompanied by the variation in electric current in the pump drive motor or the variation of voltage at the terminal of the pump drive motor. Further, the fuel supply amount being substantially constant means that the fuel supply amount can vary within a range that can ensure the desired accuracy of detection (within the predetermined error range).

The abnormality detection apparatus for a fuel supply system according to the present invention may preferably be so constructed that (2) the state change detection unit detects the variation of the energization electric current of the pump drive motor after the set pressure is changed. Therefore, in the abnormality detection apparatus for a fuel supply system according to the present invention, whether or not the changing of the set pressure is normally completed is reliably determined by determining whether or not there is occurred the variation of the electric current in the pump drive motor when the rotational load of the fuel pump is varied by changing the set pressure, so that the electric current in the pump drive motor with respect to the same drive voltage is varied. Here, the variation of the electric current can be detected not only as a variation of the voltage across the shunt resistor connected in series with the pump drive motor, but also can be detected by various detection methods known in the art. Further, for example, the variation of the electric current can be detected as a variation of the pump rotational speed in a state under a constant voltage of the pump.

The abnormality detection apparatus for a fuel supply system according to the present invention may preferably be so constructed that (3) the fuel consumption unit is constituted by a fuel injection unit forming part of an internal combustion engine, and the state change detection unit is operative to detect the variation of the state in response to the energization of the pump drive motor at an idle operation time when a fuel injection amount from the fuel injection unit is maintained substantially constant during an operation of the internal combustion engine.

In this case, when the load torque of the pump drive motor varies by the normal change in the fuel pressure, the rotational speed of the pump drive motor and the fuel pump is varied, so that the electric current in the pump drive motor is varied. Further, when the fuel injection amount is substantially constant, the voltage of the pump drive power can be made substantially constant, so that the electric current in the pump drive motor in response to the variation of the fuel pressure can be obviously varied, thereby making it possible to detect the variation of the electric current with low noise. Therefore, whether or not the fuel pressure changing operation is normal or abnormal can be reliably detected by whether or not there is a variation of the electric current in the pump drive motor, without using a fuel pressure sensor or the information detected by the air-fuel ratio sensor.

The abnormality detection apparatus for a fuel supply system according to the present invention may preferably be so constructed that (4) the fuel consumption unit is constituted by a fuel injection unit forming part of an internal combustion engine, and the state change detection unit is operative to detect the variation of the state in response to the energization of the pump drive motor at a fuel cut time when the fuel injection from the fuel injection unit is temporally stopped during the operation of the internal combustion engine.

Also in this case, when the pressure of the fuel is normally changed upon abnormality detection operation, the load torque of the pump drive motor which is driven even during the fuel cut operation is varied, so that the rotational speed of the pump drive motor and the fuel pump is varied, with the result that there is a variation in the electric current in the pump drive motor. Further, in the fuel cut state where the fuel injection amount is substantially constant or zero, there is an obvious variation of the electric current in the pump drive motor in response to the variation of the fuel pressure if the voltage of the power to drive the pump drive motor is constant, so that the variation of the electric current can be detected with low noise. Therefore, whether the fuel pressure changing operation is normal or abnormal can be reliably detected by whether or not there is the variation in the electric current in the pump drive motor.

The abnormality detection apparatus for a fuel supply system according to the present invention may preferably be so constructed that (5) the fuel consumption unit is constituted by a fuel injection unit forming part of an internal combustion engine, and the operation unit is operative to change the set pressure of the variable fuel pressure adjustment valve from a low pressure in the plurality of set pressures to a high pressure in the plurality of set pressures when the internal combustion engine is stopped, and the state change detection unit is operative to detect the variation of the state in response to the energization of the pump drive motor when the internal combustion engine is stopped.

By the construction as described above, the set pressure of the variable fuel pressure adjustment valve becomes high pressure when stopping the internal combustion engine, so that the state of the high set pressure is maintained after stopping the internal combustion engine, with the result that the generation of fuel vapor at the start and immediately after stopping the engine is effectively suppressed, thereby making it possible to improve the performance of starting the internal combustion engine. Further, the energization state of the pump drive motor can be detected by the state change detection unit by utilizing the changing of the fuel pressure (set pressure) by the variable fuel pressure adjustment valve when stopping the internal combustion engine, so that whether the fuel pressure changing operation is normal or abnormal can be reliably detected. Accordingly, even though the internal combustion engine is stopped after the operation at a low fuel pressure, if there is occurred an abnormality of the fuel pressure changing operation prior to the stop of the internal combustion engine, the abnormality can be reliably detected prior to the stop of the internal combustion engine, with the result that there is no possibility that the abnormality remains undetected until after the internal combustion engine is started next time.

The abnormality detection apparatus for a fuel supply system according to the present invention may preferably be so constructed that (6) the state change detection unit is operative to detect the variation of the state in response to the energization of the pump drive motor from the time when a signal for instructing the stop of the pump drive motor is generated to the time when the pump drive motor is stopped for stopping the internal combustion engine.

In this case, at the generation timing of the signal to instruct the stop of the pump drive motor, for example at the power supply stop time, which is the changing time from the voltage of the pump drive motor in operation to the power supply stop time voltage, there is generated a counter electromotive force corresponding to the load torque immediately prior to the stop timing of power supply and the rotational speed of the pump drive motor. Therefore, the electric current in the pump drive motor at the power supply stop time and the required stop time, from the power supply stop to the actual rotation stop of the pump drive motor, depends on a rotational speed and a load torque of the pump drive motor immediately prior to the generation of the signal to instruct the stop of the pump drive motor. As a consequence, the duration of time when the abnormality of the fuel pressure changing operation can be detected is increased. This means that the abnormality of the fuel pressure changing operation can be reliably detected prior to the stop of the driving, if there is occurred an abnormality of the fuel pressure changing operation prior to the stop of the internal combustion engine.

The abnormality detection apparatus for a fuel supply system according to the present invention may preferably be so constructed that (7) the state change detection unit is operative to detect a stopping time required to stop the pump drive motor based on the variation of either one of the electric current and the voltage, and the abnormality determination unit is operative to determine whether an abnormality is generated for changing the set pressure of the variable fuel pressure adjustment valve in accordance with the required stopping time detected.

By the construction as described above, the required stopping time at the power supply stop time of the pump drive motor varies by whether or not there is occurred an abnormality of fuel pressure changing operation by the variable fuel pressure adjustment valve, so that the duration of time when the abnormality of the fuel pressure changing operation can be detected is increased. This means that the abnormality of the fuel pressure changing operation can be reliably detected prior to the stop of the driving, if there is occurred an abnormality of the fuel pressure changing operation prior to the stop of the internal combustion engine.

### Advantageous Effects of Invention

According to the present invention, the abnormality detection apparatus for a fuel supply system is so constructed that when the fuel supply amount to the fuel consumption unit is substantially constant, the set pressure of the variable fuel pressure adjustment valve is changed from the first set pressure to the second set pressure, then the variation of the energization state of the pump drive motor after the changing of the set pressure is detected by the state change detection unit, and then whether there is occurred an abnormality of the fuel pressure changing by the variable fuel pressure adjustment valve is determined based on the information this detected, so that the abnormality detection apparatus for a fuel supply system according to the present invention can reliably detect an abnormality of the fuel pressure changing without using an expensive fuel pressure sensor or the information detected by the air-fuel ratio sensor, thereby making it possible to provide a low-cost abnormality detection apparatus for a fuel supply system that can reliably detect an abnormality of the fuel pressure changing operation of a fuel supply system capable of changing the fuel pressure.

### BRIEF DESCRIPTION OF THE DRAWINGS

FIG. 1 is a schematic construction view of a fuel supply system according to a first embodiment of the present invention.

FIG. 2 is a schematic block construction view of an abnormality detection apparatus for the fuel supply system according to the first embodiment of the present invention.

FIG. 3 is a cross-sectional view showing the construction of a variable fuel pressure adjustment valve forming part of the fuel supply system according to the first embodiment of the present invention.

FIG. 4 is an explanation view of a fuel pressure changing abnormality detection operation to be performed when a fuel injection amount comes to be substantially constant in the abnormality detection apparatus for the fuel supply system according to the first embodiment of the present invention.

FIG. 5 is a schematic flow chart showing a control process of the fuel pressure changing abnormality detection operation to be performed when the fuel injection amount comes to be substantially constant in the abnormality detection apparatus for the fuel supply system according to the first embodiment of the present invention.

FIG. 6 is an explanation view of a fuel pressure changing abnormality detection operation to be performed immediately before the engine stop in the abnormality detection apparatus for the fuel supply system according to a second embodiment of the present invention.

FIG. 7 is a schematic flow chart showing one embodiment of the fuel pressure changing abnormality detection operation to be performed when a fuel pump is stopped immediately before the engine stop in the abnormality detection apparatus for the fuel supply system according to the second embodiment of the present invention.

FIG. 8 is a schematic flow chart showing another embodiment of the fuel pressure changing abnormality detection operation to be performed when a fuel pump is stopped immediately before the engine stop in the abnormality detection apparatus for the fuel supply system according to the second embodiment of the present invention.

FIG. 9 is a schematic flow chart showing the other embodiment of the fuel pressure changing abnormality detection operation to be performed when a fuel pump is stopped immediately before the engine stop in the abnormality detection apparatus for the fuel supply system according to the second embodiment of the present invention.

### DESCRIPTION OF EMBODIMENTS

The preferred embodiments of the present invention will hereinafter be described with reference to the accompanying drawings.

### First Embodiment

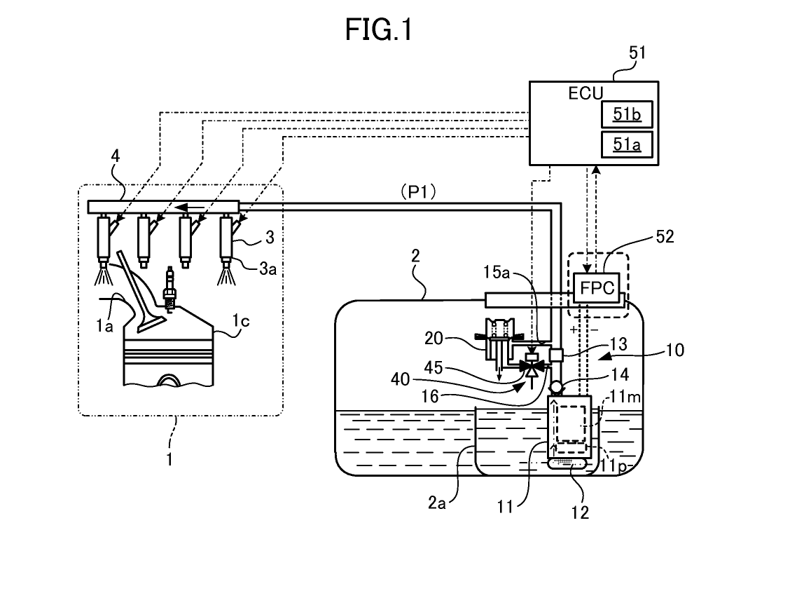

FIGS. 1 to 5 show a first embodiment of the abnormality detection apparatus for a fuel supply system according to the present invention. The present invention is exemplified by the present embodiment which is applied to a fuel supply system of an internal combustion engine for use in a vehicle. The fuel supply system described hereafter comprises a sub-tank provided in the fuel tank, the sub-tank having fuel pump and the like being arranged therein, and a known jet pump not shown as a fuel transfer means for introducing the fuel to the sub-tank as much as successively consumed by an engine.

First, the structure of the fuel supply system will be described hereinafter.

As shown in FIG. 1, the fuel supply system according to the present embodiment comprises a fuel tank 2, a fuel pumping mechanism 10, a pressure regulator 20 and a set pressure changing operation mechanism 40, the fuel tank 2 being adapted to store a fuel, for example gasoline, to be consumed by an engine 1 (a fuel consumption unit), the fuel pumping mechanism 10 being adapted to pump and supply the fuel stored in a sub-tank 2a (hereinafter simply referred to as “fuel tank 2”) of the tank 2 to a plurality of injectors 3 (a fuel injection unit of an internal combustion engine, a fuel consumption unit) of the engine 1, the pressure regulator 20 (variable fuel pressure adjustment valve) being adapted to set the fuel pressure to a predetermined system pressure P1 by introducing the fuel supplied to the injectors 3 from the fuel pumping mechanism 10 and to change the system pressure P1 to any one of a plurality of set pressures, for example either one of a high set pressure or a low set pressure, the set pressure changing operation mechanism 40 (operation unit) adapted to change the set pressure of the pressure regulator 20 by a three-way electromagnetic valve 45 from the current set pressure (any one of a plurality of set pressures) to the other one of the high set pressure or the low set pressure, which is different from the current pressure.

The engine 1 is a multi-cylinder internal combustion engine mounted on a vehicle, for example a four-cycle gasoline engine, and the injectors 3 provided in correspondence to a plurality of cylinders 1c of the engine 1, for example, have nozzle hole side end portions 3a thereof exposed to inside intake ports 1a corresponding to each of cylinders 1c. Further, the fuel from the fuel pumping mechanism 10 is adapted to be distributed to the injectors 3 through a delivery pipe 4.

The fuel pumping mechanism 10 comprises a fuel pump unit 11 adapted to pump, pressurize and discharge the fuel in the fuel tank 2, a suction filter 12 adapted to suppress the inhalation of foreign matters in the inlet side of the fuel pump unit 11, a fuel filter 13 adapted to remove the foreign matters in the discharged fuel at the discharge port side of the fuel pump unit 11, and a check valve 14 (non-return valve) provided in upstream side or downstream side of the fuel filter 13.

The fuel pump unit 11, not shown in detail, for example, comprises a fuel pump 11p having an impeller for actuation of the pump, and a pump drive motor 11m which is a built-in DC motor for operating the fuel pump 11p. The fuel pump unit 11 is adapted to be driven and stopped through the energization control of an Electronic Control Unit (hereinafter simply referred to as “ECU”) 51 described later.

The fuel pump unit 11 is adapted to pump the fuel from the fuel tank 2, pressurize the fuel and discharge the fuel, as well as is adapted to have the discharge amount per unit time and the discharge pressure varied through having the rotational speed [rpm] of the pump drive motor 11m varied in response to the load torque against the same supply voltage or having the rotational speed of the pump drive motor 11m varied in response to the variation of the supply voltage.

The check valve 14 is adapted to open the valve in the direction of supplying the fuel from the fuel pump unit 11 to the injectors 3. On the other hand, the check valve 14 is adapted to close the valve in the backflow direction from the injectors 3 to the fuel pump unit 11, so that the backflow of the pressurized supply fuel is suppressed.

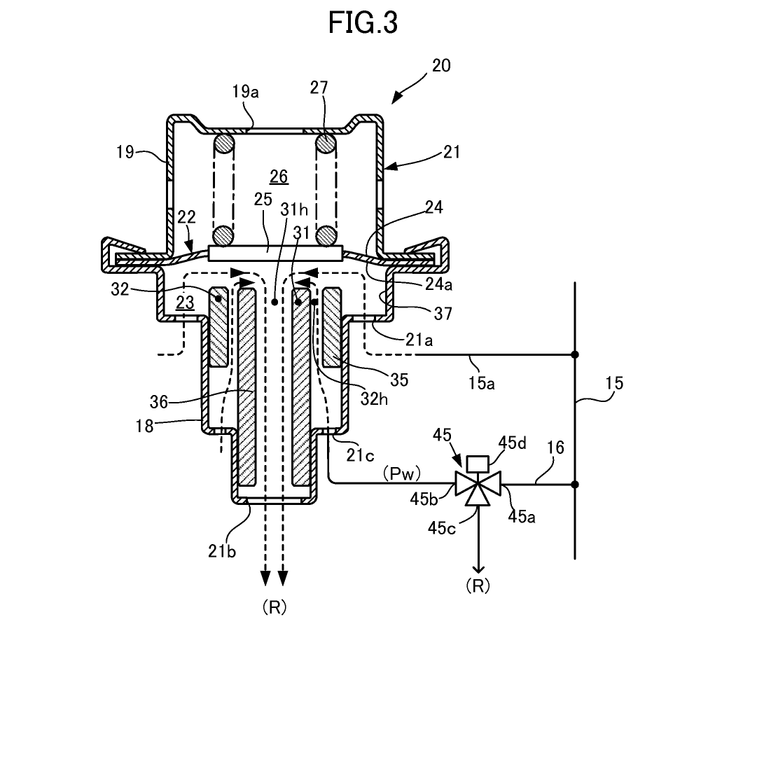

As shown in FIG. 3, the pressure regulator 20 includes a housing 21 having a fluid inlet port 21a through which the fuel is introduced and a fluid outlet port 21b through which the fuel is discharged, the housing 21 being formed by a pair of concaved housing member 18, 19 being caulking-fastened with each other in an outer peripheral portion thereof.

Provided inside the housing 21 is a pressure regulating member 22 being partition shaped and partitioning the inside of the housing 21 into two chambers. The pressure regulating member 22 is formed by a partition wall 24 and a movable valve body portion 25 integrated with each other, the partition wall 24 forming a pressure regulating chamber 23 between the partition wall 24 and the housing 21, the pressure regulating chamber 23 communicating with the fluid inlet port 21a, the movable valve body portion 25 being displaced by an opening degree in response to the fuel pressure in the pressure regulation chamber 23 in the valve opening direction to have the pressure regulation chamber 23 communicated with the fluid outlet port 21b. The partition wall 24 is adapted to constantly receive the fuel pressure in the pressure regulating chamber 23 on one side. Further, the partition wall 24 forming a part of the pressure regulating member 22 is constructed to form a back pressure chamber 26 on the other side between the housing 21 and the partition wall 24, the back pressure chamber 26 applying a back pressure to the pressure regulating chamber 23. Disposed inside the back pressure chamber 26 is a compression coil spring 27 (resilient member) urging the movable valve body portion 25 forming a part of the pressure regulating member 22 in the valve closing direction. Further, the other housing member 19, forming the back pressure chamber 26 together with the pressure regulating member 22, has at least one atmospheric pressure introducing hole 19a formed therein.

To be specific, the partition wall 24 forming a part of the pressure regulating member 22 is constituted by, for example, a flexible diaphragm, which is a base cloth material layer integrally adhered thereon with a rubber layer hardly deteriorated by the fuel, while the movable valve body portion 25 forming a part of the pressure regulating member 22 is constituted by, for example, a valve plate made of a disk-shaped metal.

Meanwhile, inside the housing 21, a first valve seat portion 31 and a second valve seat portion 32 are concentrically disposed so as to face the movable valve body portion 25 forming a part of the pressure regulating member 22 within the pressure regulating chamber 23, the first valve seat portion 31 and the second valve seat portion 32 being formed respectively by an outer tubular member 35 and an inner tubular member 36 differing in diameter from each other and coaxially disposed. Here, the first valve seat portion 31 has a discharge passage 31h formed on the inner circumferential side thereof, the discharge passage 31h communicating with the fluid outlet port 21b, while the second valve seat portion 32 has an operating pressure introduction passage 32h formed on the inner circumferential side thereof, between the first valve seat portion 31 and the second valve seat portion 32.

The housing 21, the pressure regulating member 22 and the outer tubular member 35 of the pressure regulator 20 form an introduction passage 37 of an annular shape, the introduction passage 37 introducing the fuel discharged from the fuel pump unit 11 through the fluid inlet port 21a positioned the radially outside to have the fuel pressure received by the partition wall 24. Further, the discharge passage 31h inside the first valve seat portion 31 is in communication with the fluid outlet port 21b of the housing 21, while the operating pressure introduction passage 32h between the first valve seat portion 31 and the second valve seat portion 32 is in communication with an operating pressure introducing hole 21c of the housing 21.

Further, the fluid inlet port 21a forming part of the housing 21 is connected through a branch passage 15a to a fuel passage 15 which is a circuit portion disposed on downstream side of the check valve 14 of the fuel pumping mechanism 10, while the operating pressure introducing hole 21c forming part of the housing 21 is connected via the three-way electromagnetic valve 45 to a branch passage 16 which is a circuit portion disposed on the upstream side of the check valve 14 of the fuel pumping mechanism 10.

The three-way electromagnetic valve 45 which constitutes a set pressure changing operation mechanism 40 comprises a first port 45a, a second port 45b, and a third port 45c, the first port 45a being connected to the branch passage 16 of the fuel pumping mechanism 10, the second port 45b being connected to the operating pressure introducing hole 21c of the housing 21, the third port 45c equivalent to a drain port being open in the fuel tank 2. The three-way electromagnetic valve 45 is an electromagnetic valve capable of setting to one of any of a supply state and a drain state, the supply state being a state in which the first port 45a and the second port 45b are held in communication with each other and the third port 45c is closed, so that the fuel pressurized by the fuel pumping mechanism 10 is introduced into the operating pressure introduction passage 32h, the drain state being a state in which the second port 45b and the third port 45c are held in communication with each other and the first port 45a is closed, so that the operating pressure introduction passage 32h is open to the fuel tank 2.

Further, by having an energization state and an excitation state of an electromagnetic operation unit 45d controlled by the ECU 51, the three-way electromagnetic valve 45 is controlled to be switched between the drain state and the supply state as described above. The branch passage 16, the three-way electromagnetic valve 45 and the ECU 51 collectively constitute the set pressure changing operation mechanism 40 that performs changing control of the set pressure of the pressure regulator 20.

When the three-way electromagnetic valve 45 of the set pressure changing operation mechanism 40 is in the drain state, i.e., when a fuel pressure Pw in the operating pressure introduction passage 32h is as low as the pressure in the fuel tank 2, an area of a substantial pressure receiving area of the pressure regulating member 22 includes only the area of an annular pressure-receiving surface 24a side of the partition wall 24 surrounding the movable valve body portion 25. On the other hand, when the three-way electromagnetic valve 45 is in a supply state, i.e., when the fuel pressure Pw in the operating pressure introduction passage 32h is increased due to the pressurized fuel supplied to the operating pressure introduction passage 32h, the pressure receiving area of the pressure regulating member 22 includes not only the area of the annular pressure-receiving surface 24a side of the partition wall 24 but also an area of an annular pressure receiving area (not shown in the drawings) facing the second valve seat portion 32 and the operating pressure introduction passage 32h. Therefore, the area of the pressure receiving area of the pressure regulating member 22 varies depending on whether or not the operating pressure (pressurized fuel) is supplied to the operating pressure introduction passage 32h. When the area of the pressure receiving area of the pressure regulating member 22 is increased, the fuel pressure needed to open the pressure regulating member 22 against the urging force of the compression coil spring 27 can be low, with the result that the level of fuel pressure regulation in the annular introduction passage 37 is lowered. On the other hand, when the operating pressure introduction passage 32h is opened to the fuel tank 2, the area of the pressure receiving area of the pressure regulating member 22 is reduced, so that the fuel pressure needed to open the pressure regulating member 22 against the urging force of the compression coil spring 27 must be high, with the result that the level of fuel pressure regulation in the annular introduction passage 37 is increased.

Thus, the pressure regulator 20 has a pressure regulating function to regulate the fuel pressure of the fuel being introduced into the annular introduction passage 37 in the pressure regulating chamber 23 to a predetermined set pressure, as well as is capable of changing the set pressure to any one of the predetermined high set pressure and the predetermined low set pressure by selectively introducing the fuel discharged from the fuel pump unit 11 and supplied to the injectors 3 into the operating pressure introduction passage 32h in the pressure regulating chamber 23.

In addition, the high set pressure of the pressure regulator 20 is set to a fuel pressure (usually, 324 kPa or higher in gauge pressure) under which fuel vapor is hard to occur even if the fuel temperature in the delivery pipe 4 becomes high immediately after stopping an engine. In contrast, the low set pressure is, for example, at 200 kPa in gauge pressure under which fuel vapor is hard to occur when the fuel temperature in the delivery pipe 4 becomes relatively low during traveling.

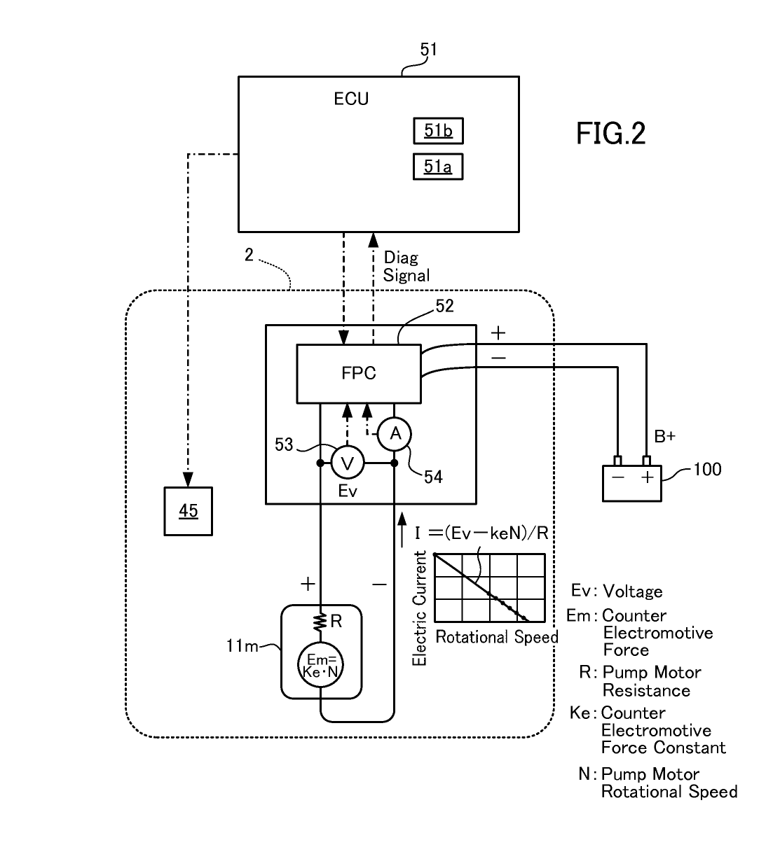

The ECU 51 comprises, for example, a Central Processing Unit (hereinafter simply referred to as “CPU”), a Read Only Memory (hereinafter simply referred to as “ROM”), a Random Access Memory (hereinafter simply referred to as “RAM”), a backup memory consisting of a non-volatile memory such as an Electrically Erasable and Programmable Read Only Memory (hereinafter simply referred to as “EEPROM”), as well as an input interface circuit and an output interface circuit. The ECU 51 is adapted to take in an ON/OFF signal of the ignition switch of the vehicle, and is adapted to be supplied with a power from the battery 100 as shown in FIG. 2. Further, the input interface circuit of the ECU 51 is connected with various sensors and is adapted to take in sensor information from the sensor group through the input interface circuit including an A/D converter or the like. The output interface circuit of the ECU 51 is connected with the injectors 3, the fuel pump unit 11, a relay switch for controlling actuators such as the three-way electromagnetic valve 45, a switching element for variably controlling a drive current of the fuel pump unit 11 and the like.

By executing a control program stored in the ROM, the ECU 51 is capable of performing various known controls, such as an electronic throttle control, fuel injection amount control, ignition timing control, fuel cut control, and variable valve timing control. For example, the ECU 51 is adapted to calculate the basic injection amount required for each combustion based on an intake air amount detected by an air flow meter and an engine rotational speed detected by a crank angle sensor, to calculate a fuel injection amount corrected by various types of corrections according to an operating condition of the engine 1, an air-fuel ratio feedback correction and the like, and to drive the corresponding injectors 3 open for the fuel injection time corresponding to the fuel injection amount. The fuel injection time in this case is set to maintain a stoichiometric air-fuel ratio in accordance with the set pressure value of the fuel supplied to the injectors 3.

Further, the ECU 51 is equipped with functions to generate a command value of a drive voltage of the pump drive motor 11m corresponding to the discharge amount of the fuel pump unit 11, so as to optimize the discharge amount of the fuel pump unit 11 in response to the fuel injection amount required for the operation of the engine 1, and to perform a feedback control of the driving voltage of the pump drive motor 11m in cooperation with a fuel pump controller 52 to be described later.

Further, the ECU 51 is adapted to repeatedly determine a load state of the engine 1 during the operation of the engine 1, based on sensor information from various sensors and a map information or set values preliminarily stored in the ROM, and to regulate the fuel pressure of the fuel from the fuel pump unit 11 to the low set pressure of the pressure regulator 20 when the engine 1 is in a partial load operation range, leading the three-way electromagnetic valve 45 to a non-excited state wherein the three-way electromagnetic valve 45 is returned to the supply state (hereinafter referred to as “OFF state”). On the other hand, the ECU 51 is adapted to change the fuel pressure of the fuel from the fuel pump unit 11 to the high set pressure of the pressure regulator 20 at the start of the engine 1 or immediately before the stop of the engine 1, leading the three-way electromagnetic valve 45 to an excited state wherein the three-way electromagnetic valve 45 is returned to the drain state (hereinafter referred to as “ON state”). Therefore, the set values stored in the ROM and the backup memory of the ECU 51 respectively include the set value of the high set pressure of the fuel and the set value of the low set pressure of the fuel, and the map information stored in the ROM and the backup memory includes the maps for determining the engine operation load and for changing the fuel pressure in accordance with the determination result and the like.

Moreover, as a part of the OBD functions, the ECU 51 is equipped with functions to constantly diagnose during the operation of the engine 1 whether or not the exhaust emission is in a state in which the exhaust emission can be maintained within the regulatory range and to lamp an MIL (Malfunction Indicator Lamp) not shown when there is occurred an abnormality such as a failure or the like which may cause the exhaust emission to deviate from the regulatory range.

As shown in FIGS. 1 and 2, a fuel pump controller 52 for controlling the operation of the fuel pump unit 11 is provided on an upper portion of the fuel tank 2, the fuel pump controller 52 having a voltage detection unit 53 and an electric current detection unit 54 arranged therein, the voltage detection unit 53 being adapted to detect a terminal voltage of the pump drive motor 11m, the electric current detection unit 54 being adapted to detect an electric current of the pump drive motor 11m.

The fuel pump controller 52 is adapted to control a voltage to be applied to the pump drive motor 11m of the fuel pump unit 11, in accordance with a deviation between the detection signal of the voltage detection unit 53 for detecting the terminal voltage of the pump drive motor 11m and a pump control signal from the ECU 51 (command input of the voltage feedback control described above), and to supply a diagnostic signal (Diag signal in FIG. 2) to the ECU 51, the diagnostic signal being indicative of an operation state of the pump drive motor 11m for the abnormality diagnosis of the fuel pumping mechanism 10.

The fuel pump controller 52 is arranged to be supplied with a power supply from the battery 100 and is communicatively connected with the ECU 51. Further, the fuel pump controller 52 has a relay switch circuit and a switching element not shown or the like provided therein, the relay switch being adapted to switch ON/OFF the power supply to the pump drive motor 11m of the fuel pump unit 11 in response to the pump control signal from the ECU 51, the switching element being adapted to variably control the voltage applied to the pump drive motor 11m or the supply energy supplied to the pump drive motor 11m. The switching element may, for example, be constituted by transistors of MOS-FET form for variably controlling the supply energy supplied to the coil of the pump drive motor 11m of the fuel pump unit 11 in response to a PWM (Pulse Width Modulation) input signal. The fuel pump controller 52 may have, in lieu of the electric current detection unit 54, a rotational speed detecting unit arranged to detect the rotational speed [rpm] of the pump drive motor 11m under a substantially constant driving voltage of the pump drive motor 11m.

On the other hand, the ECU 51 has a state change detection section 51a (a state change detection unit) and all abnormality determination section 51b (abnormality determination unit), as a plurality of functional units implemented by a control program stored in the ROM, the state change detection section 51a being adapted to detect the variation of the energization state of the pump drive motor 11 after changing the set pressure of the pressure regulator 20 based on the diagnostic signal from the fuel pump controller 52, the abnormality determination section 51b being adapted to determine whether or not there is occurred an abnormality in changing the set pressure of the pressure regulator 20 based on the information detected by the state change detection section 51a.

In addition, the state change detection section 51a of the ECU 51 is adapted to operate the three-way electromagnetic valve 45 of the set pressure changing operation mechanism 40 so that the set pressure of the pressure regulator 20 is changed from the low set pressure, which is the first set pressure of the plurality of set pressures, to the high set pressure, which is the second set pressure of the plurality of set pressures, under certain special condition in which the fuel injection amount [g/sec] of the injectors 3 of the engine 1 constituting the fuel consumption unit is substantially constant and the fuel supply amount of the fuel pump unit 11 per unit time and the terminal voltage of the pump drive motor 11m respectively is substantially constant. The state change detection section 51a is further adapted to detect the variation of the electric current of the pump drive motor 11m caused by the changing of the set pressure based on the diagnostic signal from the fuel pump controller 52.

The abnormality determination section 51b of the ECU 51 is adapted to perform a fuel pressure changing operation, a voltage maintenance operation and an abnormality determination operation: the fuel pressure changing operation being an operation to set the set pressure (fuel pressure) of the pressure regulator 20 from the low set pressure to the high set pressure by changing the excitation state of the three-way electromagnetic valve 45 from the OFF state, wherein the operating pressure is supplied to the operating pressure introduction passage 32h, to the ON state, wherein the operating pressure is released from the operating pressure introduction passage 32h, under the certain special condition in which the fuel injection amount from the injectors 3 (the fuel supply amount to the injectors 3) is maintained substantially constant; the voltage maintenance operation being an operation to have the pump drive voltage to be applied to the pump drive motor 11m of the fuel pump unit 11 maintained at a constant voltage at least during a time period ranging from before the fuel pressure changing operation to after the fuel pressure changing operation; and the abnormality determination operation being an operation to determine whether the fuel pressure changing by the changing of the set pressure of the pressure regulator 20 is normally performed or there is occurred an abnormality in the fuel pressure changing based on the drive electric current [A] of the pump drive motor 11m which is inputted as the diagnostic signal from the state change detection section 51a (or based on the rotational speed [rpm] of the pump drive motor 11m).

In the abnormality determination operation explained herein, the changing of the fuel pressure is determined to be normally completed if there is occurred a variation in the energization state of the pump drive motor 11m in response to changing the set pressure of the pressure regulator 20, for example an obvious variation (a significant variation beyond a fluctuation margin of error) of the electric current of the pump drive motor 11 is occurred after changing the set pressure, while, on the other hand, an abnormality to prevent the changing of the fuel pressure is determined to have occurred, if the obvious variation of the electric current of the pump drive motor 11 is not occurred after changing the set pressure. Alternatively, in the abnormality determination operation, the changing of the fuel pressure may be determined to be normally completed if there is occurred an obvious variation of the rotational speed of the pump drive motor 11m, which is equivalent to the obvious variation of the electric current of the pump drive motor 11m, after changing the set pressure of the pressure regulator 20, while, on the other hand, an abnormality to prevent the changing of the fuel pressure is determined to have occurred, if such an obvious variation of the rotational speed of the pump drive motor 11m is not occurred after changing the set pressure.

The certain special condition in which the fuel supply amount per unit time to the injectors 3 is maintained substantially constant includes, for example, a state in which the fuel injection amount of the injectors 3 is equal to or smaller than a certain amount and is substantially constant, specifically, (i) under idle operation of the engine 1 after warm-up operation, (ii) under fuel cut operation or cylinder deactivated operation in which the fuel injection from injectors 3 corresponding to at least a part of cylinders is temporarily suspended during the operation of the engine 1, for example, in the deceleration of the vehicle, or (iii) the state in which the fuel pressure can be changed wherein the operation of fuel pump unit 11 is continued under the state of low speed rotation of the engine 1 immediately prior to the stop of the engine 1 operation.

Next, the operation of the embodiment of the abnormality detection apparatus for fuel supply system according to the present invention will be explained hereinafter.

In the fuel supply system of the present embodiment constructed as described above, the energization to the pump drive motor 11m of the fuel pump unit 11 and the three-way electromagnetic valve 45 is stopped while the engine 1 is stopped.

At this time, the pressurized fuel is not supplied to the operating pressure introduction passage 32h of the pressure regulator 20. However the ECU 51 is stopped after changing the set pressure of the pressure regulator 20 to the high set pressure by once turning the three-way electromagnetic valve 45 to the ON state immediately prior to entering the current stopped state of the engine 1, so that the fuel pressure in a fuel pressure maintaining section ranging from the check valve 14 to the injectors 3 is maintained at a relatively high fuel pressure, wherein the fuel vapor is hard to occur.

When the engine 1 is started, the fuel pump unit 11 is activated by the ECU 51. At this time, the three-way electromagnetic valve 45 is turned ON and the pressure regulator 20 is changed to the high set pressure. Accordingly, in response to an increase of the discharge pressure of the fuel pump unit 11 and an introduction of the fuel from the fuel pump unit 11 into the annular introduction passage 37 in the pressure regulation chamber 23, the pressure of the fuel quickly reaches to the high set pressure, for example, 400 [kPa], with the result that the system pressure P1 of the high fuel pressure is supplied to the delivery pipe 4 through the fuel passage 15. Therefore, fuel supply can be started instantly with an adequate fuel pressure when to resume the fuel pumping by the fuel pumping mechanism 10.

Under a normal operating condition after a certain time has elapsed from the start of the engine 1, for example, during the partial load operation of engine 1, the low set pressure is required from the aspect of the fuel efficiency and the reliability of the fuel pump unit 11. During the partial load operation, the three-way electromagnetic valve 45 is turned to the OFF state in which the operating pressure is supplied to the operating pressure introduction passage 32h, so that the operation of the fuel pump unit 11 is continued under the state in which the set pressure of the pressure regulator 20 is changed to the low set pressure.

On the other hand, during time when the high load is demanded, the three-way electromagnetic valve 45 is turned to the ON state, so that the fuel from the fuel pump unit 11 is regulated to the high set pressure in the introduction passage 37 of the pressure regulation chamber 23.

Incidentally, when there is occurred an abnormality such as a failure to have the exhaust emission of engine 1 to deviate from the regulatory range during the operation of the engine 1, the MIL not shown needs to be lamped.

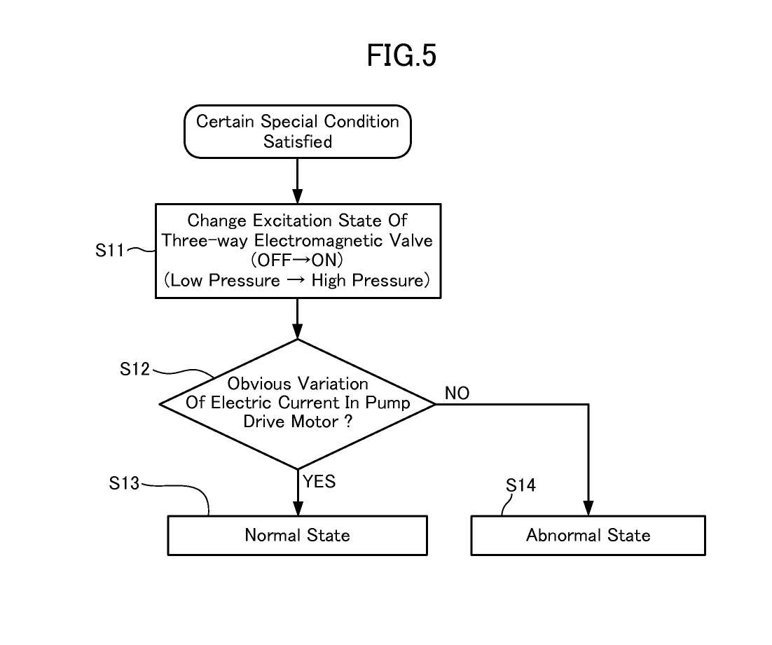

Therefore, in order to reliably perform the abnormality detection without affecting the operation of the engine 1 as much as possible, the ECU 51 is arranged to perform, in a procedure as shown in FIG. 5, the diagnosis as to whether or not the exhaust emission of engine 1 is maintained within the regulatory range, at least once during the operation of the engine 1.

This means that, under certain special condition in which the fuel supply amount of the injectors 3 is substantially constant, the state change detection section 51a of the ECU 51, first, turns the three-way electromagnetic valve 45 to the ON state so that the set pressure of the pressure regulator 20 is changed from the low set pressure to the high set pressure (Step S11), and then the state change detection section 51a of the ECU 51 detects the electric current of the pump drive motor 11m after the changing of the set pressure respectively based on the diagnostic signal from the fuel pump controller 52, the certain special condition being, for example, the state of an idle operation of the engine 1, a fuel cut operation of the engine 1, a cylinder deactivated operation of the engine 1, or the state in which the fuel pressure can be changed wherein the operation of fuel pump unit 11 is continued under the state of low speed rotation of the engine 1 immediately prior to the stop of the engine 1 operation.

Next, the abnormality determination section 51b performs the abnormality determination operation (Step S12) by determining whether there is occurred the obvious variation of the electric current of the pump drive motor 11m after the changing of the set pressure in response to the changing of the fuel pressure of the pressure regulator 20, based on the drive current of the pump drive motor 11m, which is inputted as the diagnostic signal from the state change detection section 51a.

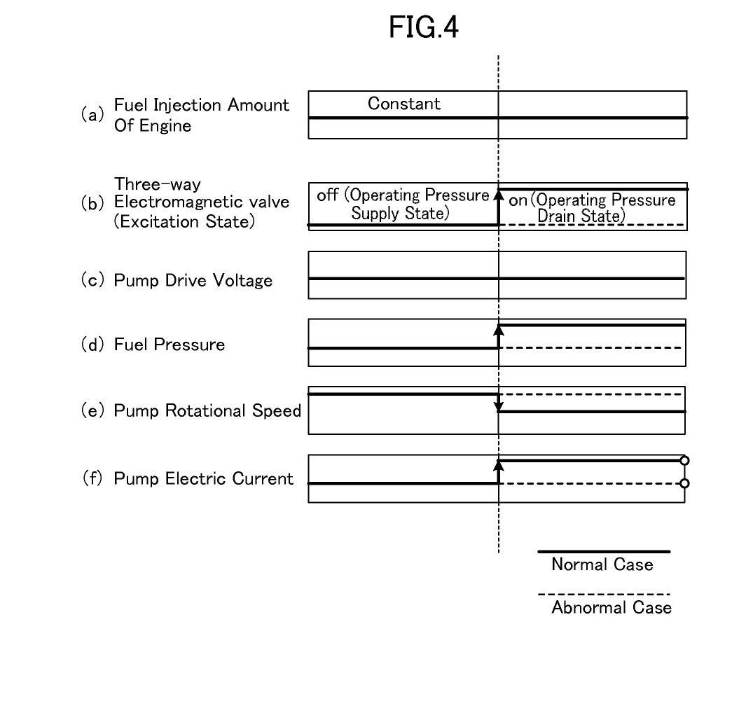

At this time, if the changing of the fuel pressure is normally completed, as shown in FIG. 4(a)-FIG. 4(f), the pressure regulator 20 is changed to the high set pressure in response to the three-way electromagnetic valve 45 being switched to the ON state, so that the fuel pressure in the fuel pressure maintaining section ranging from the check valve 14 to the injectors 3 is increased. Meanwhile, the rotational load of the pump drive motor 11m of fuel pump unit 11 (load torque) increases after the changing of the set pressure, so that the pump rotational speed is reduced, resulting in the reduction of the counter electromotive force of the pump drive motor 11m, which is proportional to the pump rotational speed, thereby increasing the electric current of the pump drive motor 11m.

Therefore, if there is occurred the obvious variation of the electric current of the pump drive motor 11m in response to the changing of the set pressure of the pressure regulator 20 (“YES” in step S12), the changing of the set pressure of the pressure regulator 20 is determined to be normally completed (Step S13). On the other hand, if there is not occurred the obvious variation of the electric current of the pump drive motor 11m in response to the changing of the set pressure of the pressure regulator 20 (“NO” in step S12), an abnormal state is determined to have occurred in which the changing of the set pressure of the pressure regulator 20 is not normally completed due to some abnormality (Step S14).

This means that the abnormality of the fuel pressure changing operation can be reliably detected, without using an expensive fuel pressure sensor or using the detection information of the air-fuel ratio sensor, by determining whether or not there is occurred the obvious variation of the electric current of the pump drive motor 11m in response to the changing of the set pressure of the pressure regulator 20.

Here, we have Em=Ke×N and Ev−Em=R×I, where the substantially constant voltage applied to the pump drive motor 11m is Ev [V], the counter electromotive force coefficient of the pump drive motor 11m is Ke, the rotation speed of the pump motor 11m is N [rpm], the electric current of the pump drive motor 11m is I, and the internal resistance of the pump drive motor 11m is R. Therefore, the electric current I can be expressed by the formula I=(Ev−Ke×N)/R, which shows that the rotational speed N and the current I are in the proportional relationship of 1:1, in which the current I decreases in response to the increase of the rotational speed N.

In addition to the effects described above, in the present embodiment, in response to the load torque of the pump drive motor 11m being varied by the fuel pressure being changed normally, the rotational speed of the fuel pump unit 11 and the pump drive motor 11m is varied, and as a result, the electric current I of the fuel pump unit 11 is varied. Further, when the amount of fuel supplied to the injectors 3 is substantially constant, the pump drive voltage Ev can be made substantially constant, so that the electric current I of the pump drive motor 11m can obviously be varied in response to the variation of the fuel pressure, thereby making it possible to detect the obvious variation of the electric current I with low noise. Therefore, whether the fuel pressure changing operation is normal or abnormal can be reliably detected by determining whether or not there is occurred a variation of the electric current in the pump drive motor 11m, without using the fuel pressure sensor or the detection information of the air-fuel ration sensor.

Furthermore, the state change detection section 51a of the ECU 51 is capable of detecting the variation of the electric current of the pump drive motor 11m or an equivalent variation of the state during the fuel cut operation in which the fuel injection from the injectors 3 is temporarily stopped during the operation of the engine 1, so that the fuel injection amount is zero or substantially constant, thus maintaining the pump drive voltage substantially constant, thereby making it possible to have the electric current in the pump drive motor 11m obviously varied in response to the variation of the fuel pressure under the state of the fuel cut. Therefore, the abnormality detection apparatus for the fuel supply system according to present invention can detect the variation of the electric current of the pump drive motor 11m with low noise, and consequently can reliably detect whether the fuel pressure changing operation is normal or abnormal.

Further, in the present embodiment, when the engine 1 is stopped, the set pressure of the pressure regulator 20 is changed from the low set pressure to the high set pressure prior to the stop of the engine 1, so that the generation of fuel vapor immediately after the stop of the engine 1 or at the start of the engine 1 is effectively suppressed, thereby improving the starting performance of the engine 1. Moreover, the variation of the energization state of the pump drive motor 11m is detected by the state change detection section 51a of the ECU 51 by utilizing the changing of the set pressure of the pressure regulator 20 at the stop of the engine 1, and consequently whether the changing operation is normal or abnormal can reliably be detected. Therefore, even though the engine 1 is stopped after continued operation thereof under a low fuel pressure, if there is occurred an abnormality of the fuel pressure changing operation prior to the stop of the engine 1, the abnormality is reliably detected prior to the completion of the stop of the engine 1, thereby eliminating the possibility to have such a problem that the abnormality cannot be detected until after the next start of the engine 1.

As will be understood from the foregoing description, in the present embodiment, the abnormality detection apparatus for a fuel supply system according to the present invention is so constructed that when the fuel injection amount of the injectors 3 of the engine 1 (the amount of fuel supplied to the fuel consumption unit) is substantially constant, the set pressure of the pressure regulator 20 is changed from the low set pressure to the high set pressure, then the variation of the energization state of the pump drive motor 11m after the changing of the set pressure is detected by the state change detection section 51a, and then whether there is occurred an abnormality of the fuel pressure changing by the pressure regulator 20 is determined based on the detected information, so that the abnormality detection apparatus for a fuel supply system according to the present invention can reliably detect an abnormality of the fuel pressure changing without using an expensive fuel pressure sensor or the information detected by air-fuel ratio sensor, thereby making it possible to provide a low-cost abnormality detection apparatus for a fuel supply system that can reliably detect an abnormality of the fuel pressure changing operation of the fuel supply system capable of changing the fuel pressure.

### Second Embodiment

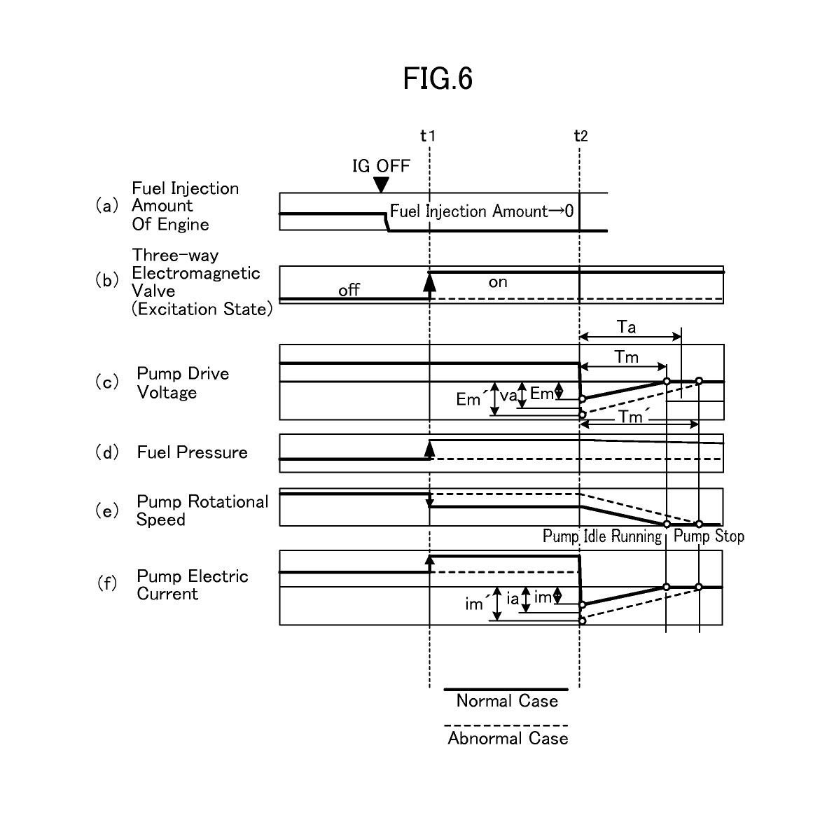

FIGS. 6 to 9 are the views showing a second embodiment of the abnormality detection apparatus of a fuel supply system according to the present invention. The present embodiment has an overall structure substantially similar to the first embodiment described above, and only the abnormality detection method of the abnormality detection apparatus is different from the first embodiment. Therefore, the explanation of the second embodiment of the abnormality detection apparatus for a fuel supply system will be omitted hereinafter with the constitutional elements and parts the same as those of the first embodiment of the abnormality detection apparatus for a fuel supply system bearing the same reference numerals of the first embodiment of the abnormality detection apparatus for a fuel supply system and only the differences from the first embodiment will be described hereinafter.

In the present embodiment, the ECU 51 is adapted to set the three-way electromagnetic valve 45 to the ON state so as to set the set pressure of the pressure regulator 20 from the low set pressure to the high set pressure, under a certain condition in which the fuel pressure can be changed wherein the engine 1 is in a state of low speed rotation immediately prior to the stop of the engine 1 and the operation of the fuel pump unit 11 is being continued. Then, the state change detection section 51a of the ECU 51 is adapted to detect the variation of the energization state of the pump drive motor 11m based on the diagnosis signal from the fuel pump controller 52, in a required stop time, from the moment of the pump drive voltage decrease (the generation of a signal to instruct the stop of the pump drive motor 11m) to the actual stop of the operation of the pump drive motor 11m, when the pump drive motor 11m is stopped to stop the engine 1.

If the changing of the fuel pressure is normally completed, as shown in FIG. 6(a)-FIG. 6(f), the set pressure of the pressure regulator 20 is changed to the high set pressure in response to the three-way electromagnetic valve 45 being switched to the ON state, resulting in the increase of the fuel pressure in the fuel pressure maintaining section ranging from the check valve 14 to the injectors 3, while the pump rotational speed is decreased in response to the increase of the rotation torque (load torque) of the pump drive motor 11m of the fuel pump unit 11 caused by the changing of the set pressure, resulting in the reduction of the counter electromotive force of the pump drive motor 11m, which is in proportion to the rotational speed of the pump, thereby having the electric current of the pump drive motor 11m once increased.

In the present embodiment, after the electric current of the pump drive motor 11m is once increased in response to the changing of the set pressure of the pressure regulator 20, the pump drive voltage is switched to zero (See FIG. 6(c)).

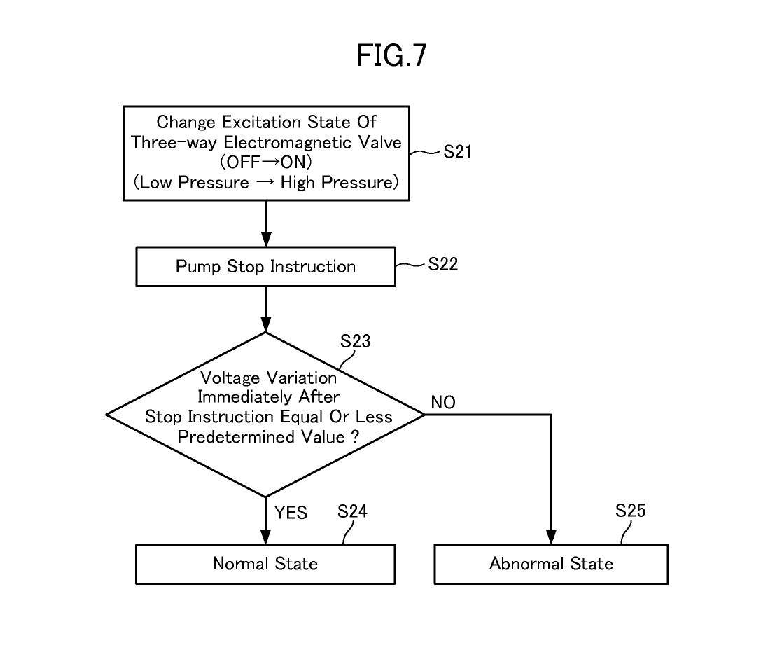

To be more specific, as shown in FIG. 6(a), under certain condition in which the fuel supply amount to the injectors 3 is substantially constant, corresponding to the injection amount being zero, for example, in the state that the fuel pressure can be changed wherein the engine 1 is in a state of low speed rotation immediately prior to the stop of the engine 1 and the operation of the fuel pump unit 11 is being continued, the ECU 51 is adapted to switch the three-way electromagnetic valve 45 to the ON state, so as to change the set pressure of the pressure regulator 20 from the low set pressure to the high set pressure, as shown in FIG. 6(b) and FIG. 7 (the timing indicated by “t1” in FIG. 6(b); Step S21).

Then, as shown in FIG. 6(c) and FIG. 7, the ECU 51 is adapted to decrease the pump drive voltage to zero in order to stop the pump drive motor 11m for stopping the engine 1, so that the stop of the pump drive motor 11m is instructed (the timing indicated by “t2” in FIG. 6(c); Step S22).

And, the variation of the energization state of the pump drive motor 11m, for example the pump drive terminal voltage of the pump drive motor 11m, is detected based on the diagnosis signal from the fuel pump controller 52, during the required stop time, from the moment t at which the pump drive voltage is decreased (stop instruction signal generation timing) to the time when the pump drive motor 11m is actually stopped.

At the time of the generation of a signal to instruct the stop of the pump drive motor 11m, i.e., the power supply stop time, where the pump drive voltage Ev supplied during the operation of the pump is switched to the power supply stop voltage Ev=0 [V], as shown in FIG. 6(c), there is generated a counter electromotive force Em in the pump drive motor 11m in operation, the counter electromotive force Em being corresponding to the rotational speed immediately prior to the power supply stop time.

To be more specific, as in the case with the first embodiment, where the substantially constant voltage applied to the pump drive motor 11m during the operation of the fuel pump unit 11 is Ev [V], the counter electromotive force coefficient of the pump drive motor 11m is Ke, the rotation speed of the pump motor 11m is N [rpm], the electric current of the pump drive motor 11m is I [A], and the internal resistance of the pump drive motor 11m is R [Ω], in response to setting the voltage applied to the pump drive motor 11m Ev to 0 [V] during the operation of the fuel pump unit 11, the counter electromotive force Em=Ke×N is generated in the pump drive motor 11m, corresponding to the rotational speed thereof, within a very short time. The terminal voltage and the electric current of the pump drive motor 11m at this time are indicative of the rotational speed of the pump drive motor 11m, as shown in FIGS. 6(c) and 6(f), in which distinctive difference is observed between the case of the normal completion of the changing of the fuel pressure (solid lines in FIGS. 6(c) and 6(f) and the case of the abnormality in prevention of the normal completion of the changing of the fuel pressure (dotted lines in FIGS. 6(c) and 6(f)).

As will be understood from the foregoing description, a voltage variation, that is amplified by the electric current I in the pump drive motor 11m at the power supply stop time or by the counter electromotive force Em, and the required stop time, from the power supply stop time to the time when the pump drive motor 11m is actually stopped, are corresponding to the rotational speed or electric current of the pump drive motor 11m immediately prior to the stop instruction.

Therefore, as shown in FIG. 7, if the voltage variation caused by the counter electromotive force immediately after the stop instruction of the pump drive motor 11m is a variation Em, which is equal to or smaller than a predetermined value “va”, this state is determined to be a normal state in which the fuel pressure changing has been normally completed (See the solid lines in FIG. 6(c); Step S23, S24). On the other hand, however, if the voltage variation caused by the counter electromotive force immediately after the stop instruction of the pump drive motor 11m is a variation Em′, which is larger than the predetermined value “va”, this state is determined to be an abnormal state in which there is occurred an abnormality that prevents the normal changing of the fuel pressure (See the dotted lines in FIG. 6(c); Step S23, S25).

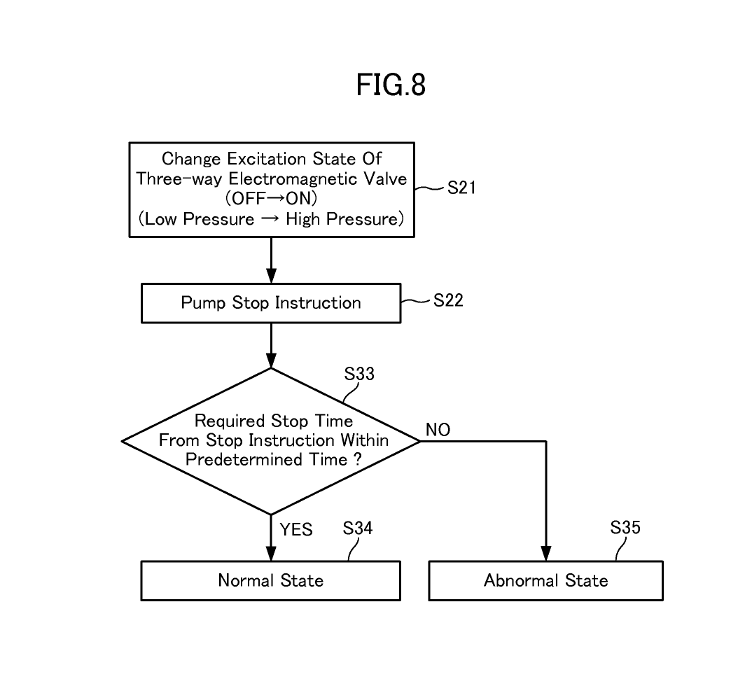

Alternatively, as shown in FIG. 8, when there is generated a variation of the electric current caused by the counter electromotive force immediately after the stop instruction of the pump drive motor 11m after the Steps S21, S22, if the required stop time from the stop of power supply to the pump drive motor 11m to the actual stop of the operation of the pump drive motor 11m is Tm, which is within a predetermined time Ta (e.g., 0.1 second), this state is determined to be a normal state in which the fuel pressure changing has been normally completed (See the solid lines in FIG. 6(c); Step S33, S34). On the other hand, however, if the required stop time from the stop of power supply to the pump drive motor 11m to the actual stop of the operation of the pump drive motor 11m is Tm′, which is beyond the predetermined time Ta, this state is determined to be an abnormal state in which there is occurred an abnormality that prevents the normal changing of the fuel pressure (See the solid lines in FIG. 6(c); Step S33, S35).

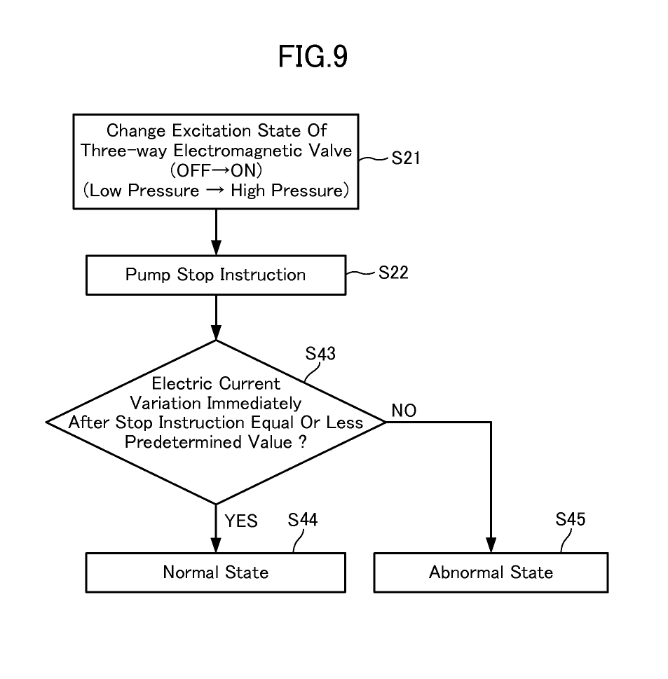

Further, as shown in FIG. 9, the variation of the electric current caused by the counter electromotive force immediately after the stop instruction of the pump drive motor 11m after the Steps S21, S22, is “im”, which is equal to or smaller than a predetermined value “ia”, this state is determined to be a normal state in which the fuel pressure changing has been normally completed (See the solid lines in FIG. 6(f); Step S43, S44). On the other hand, however, if the variation of the electric current caused by the counter electromotive force immediately after the stop instruction of the pump drive motor 11m is “im′”, which is larger than a predetermined value “ia”, this state is determined to be an abnormal state in which there is occurred an abnormality that prevents the normal changing of the fuel pressure (See the solid lines in FIG. 6(f); Step S43, S45).

As will be understood from the foregoing description, in the present embodiment, the variation amount of the voltage, the electric current, or the required stop time caused by the counter electromotive quantity in the pump drive motor 11m when the pump drive motor 11m is stopped is detected by the state change detection section 51a of the ECU 51, and based on the variation amount thus detected, whether or not there is occurred an abnormality in changing the set pressure of the pressure regulator 20 is determined by the abnormality determination section 51b of the ECU 51.

Therefore, the abnormality detection apparatus for a fuel supply system according to the present embodiment has a longer time during which an abnormality of fuel pressure changing can be detected than the time during which an abnormality of fuel pressure changing can be detected according to the first embodiment, and is capable of reliably detecting the abnormality prior to the stop of the operation, if there is occurred an abnormality of the fuel pressure changing prior to the stop of the engine 1.

In the present embodiment, the voltage variation Em and Em′ caused by the counter electromotive force immediately after the stop instruction of the pump drive motor 11m can be detected without the electronic current detection unit 54, thereby making it possible to reduce the manufacturing cost. In the case of detecting the electric current variation amount “im”, “im′” caused by the counter electromotive force immediately after the stop instruction of the pump drive motor 11m, the variation amount of the electric current can be detected with high precision, thereby making it possible to improve the precision of the abnormality detection. Further, in the case of detecting the required stop time Tm, from the stop of power supply to the pump drive motor 11m to the actual stop of the operation of the pump drive motor 11m, the Tm and the Tm′ can be detected based on the ON/OFF time, not by an absolute value of the electric current or the voltage, thereby making it possible to secure the desired precision of the abnormality detection through precisely detecting the electric current variation caused by the counter electromotive force.

In addition, the variation of the electric current can be detected not only as a variation in voltage across the electrical resistor connected in series with the pump drive motor 11m, but also, for example, by the variation of the pump rotational speed under a constant voltage of the pump drive power.

Further, in the first embodiment, the state change detection section 51a of the ECU 51 is adapted to determine whether or not there is an abnormality in the fuel pressure changing based on the electric current variation of the pump drive motor 11m under the certain special condition in which the fuel supply amount to the injectors 3 is constant, Whereas, in the second embodiment, the state change detection section 51a of the ECU 51 is adapted to determine whether or not there is an abnormality in the fuel pressure changing based on the variation of the voltage, the electric current or the required stop time caused by the counter electromotive power of the pump drive motor immediately after the stop instruction of the fuel pump. However, it goes without saying that the abnormality detection apparatus for a fuel supply system according to the present invention may employ both ways of detecting the abnormalities as described above, as well as use a plurality of variation amounts, such as the voltage variation Em, Em′ in the second embodiment, the electric current variation im, im′, the required stop time Tm Tm′ and the like. Further, in each of the embodiments, the variation of the energization state and the like of the pump drive motor 11m in response to changing from the low set pressure to the high set pressure is detected. However, in the abnormality detection apparatus for a fuel supply system according to the present invention, the variation of the energization state and the like of the pump drive motor 11m in response to changing from the high set pressure to the low set pressure may be detected as well.

The present invention can be applied not only to a fuel supply system with two-stage changeable variable fuel pressure regulator, but also to a fuel supply system with a multi-stage changeable variable fuel pressure regulator.

Further, the above embodiments have been directed to the case in which the pressure regulator 20 has the passage for supplying an discharging the operating pressure as well as the passage for pressure regulation and the passage for discharging all provided within one single housing, however, the present invention is not limited to this case, but may be applied to the case in which a plurality of fluid circuit elements are combined, as long as the abnormality detection apparatus for a fuel supply system that is capable of changing the set pressure to any one of a plurality of set pressures.

Furthermore, for convenience of explanation, the description of the above embodiments has been directed to the case in which the fuel pressure is changed under the state that the driving voltage of the pump drive motor 11m is constant. But, in the case where the amount of fuel supplied to the injectors 3 is substantially constant in operating condition of the engine 1, the drive voltage of the pump drive motor 11m does not need to be strictly constant, but the driving voltage of the pump drive motor 11m may vary within a range in which abnormalities are detected with a fairly good S/N ratio. This means that the fuel supply amount being constant includes the case in which the fuel supply amount varies within the range (predetermined error range) that secures a desired degree of the precision in abnormality detection. The variation within the predetermined error range may, for example, be smaller than the variation of the discharge flow from the fuel pressure regulator 20 within the scope of the same set pressure.

From the foregoing description, it will be appreciated that the abnormality detection apparatus for a fuel supply system according to the present invention is so constructed that when the fuel injection amount to the fuel consumption unit is substantially constant, the set pressure of the variable fuel pressure adjustment valve is changed from the first set pressure to the second set pressure, then the variation of the energization state of the pump drive motor after the changing of the set pressure is detected by the state change detection unit, and then whether there is occurred an abnormality of the fuel pressure changing by the variable fuel pressure adjustment valve is determined based on the detected information, so that the abnormality detection apparatus for a fuel supply system according to the present invention can reliably detect an abnormality of the fuel pressure changing without using an expensive fuel pressure sensor or the information detected by the air-fuel ratio sensor, thereby making it possible to provide a low-cost abnormality detection apparatus for a fuel supply system that can reliably detect an abnormality of the fuel supply system capable of changing the fuel pressure of the fuel supplied to the internal combustion engine by the fuel pump.

### EXPLANATION OF REFERENCE NUMERALS

1: engine (internal combustion engine)
2: fuel tank
2a: sub-tank
3: injector (fuel consumption unit)
4: delivery pipe
10: fuel pumping mechanism
11: fuel pump unit
11m: pump drive motor
11p: fuel pump
15: fuel passage
16: branch passage
20: pressure regulator (variable fuel pressure adjustment valve)
21: housing
22: pressure regulating member
26: back pressure chamber
31: first valve seat portion
32: second valve seat portion
40: set pressure changing operation mechanism
45: three-way electromagnetic valve
45a: first port
45b: second port
45c: third port
45d: electromagnetic operation unit
51: ECU (Electronic Control Unit)
51a: state change detection section (state change detection unit)
51b: abnormality determination section (abnormality determination unit)
52: fuel pump controller
53: voltage detection unit
54: electric current detection unit
P1: system pressure
Pw: operating pressure

1. An abnormality detection apparatus for a fuel supply system,
the supply system, comprising:
a fuel pump unit driven by a pump drive motor to supply fuel to a fuel injection unit forming a part of an internal combustion engine,
a variable fuel pressure adjustment valve that introduces the fuel to be supplied to the fuel injection unit from the fuel pump unit and is capable of adjusting to any optional one of set pressures selected from among a plurality of set pressures different in pressure from one another, and
an operation unit that operates the variable fuel pressure adjustment valve to change the one optional one of set pressures to the other one set pressure selected from among the plurality of set pressures,
the abnormality detection apparatus, comprising
a state change detection unit that operates the operation unit to change the set pressure of the variable fuel pressure adjustment valve from a first set pressure in the plurality of set pressures to a second set pressure in the plurality of set pressures when the fuel supply amount per unit time to be supplied to the fuel injection unit is maintained substantially constant, and that detects the states varied in response to an energization of the pump drive motor after the set pressure is changed, and
an abnormality determination unit that determines whether or not the change of the set pressure of the variable fuel pressure adjustment valve is in an abnormality state on the basis of a detection information detected by the state change detection unit, in which
the state change detection unit is operative to detect a variation of the state in response to the energization of the pump drive motor at a fuel cut time when the fuel injection at the fuel injection unit is temporally stopped during an operation of the internal combustion engine.

2. An abnormality detection apparatus for a fuel supply system,
the supply system, comprising:
a fuel pump unit driven by a pump drive motor to supply fuel to a fuel injection unit forming a part of an internal combustion engine,
a variable fuel pressure adjustment valve that introduces the fuel to be supplied to the fuel injection unit from the fuel pump unit and is capable of adjusting to any optional one of set pressures selected from among a plurality of set pressures different in pressure from one another, and
an operation unit that operates the variable fuel pressure adjustment valve to change the one optional one of set pressures to the other one set pressure selected from among the plurality of set pressures,
the abnormality detection apparatus, comprising
a state change detection unit that operates the operation unit to change the set pressure of the variable fuel pressure adjustment valve from a first set pressure in the plurality of set pressures to a second set pressure in the plurality of set pressures when the fuel supply amount per unit time to be supplied to the fuel injection unit is maintained substantially constant, and that detects the states varied in response to an energization of the pump drive motor after the set pressure is changed, and
an abnormality determination unit that determines whether or not the change of the set pressure of the variable fuel pressure adjustment valve is in an abnormality state on the basis of a detection information detected by the state change detection unit, in which
the state change detection unit is operative to detect a variation of the state in response to the energization of the pump drive motor when the fuel injection amount of the fuel injection unit is equal to or smaller than a certain amount for stopping the internal combustion engine.

3. An abnormality detection apparatus for a fuel supply system,
the supply system, comprising:
a fuel pump unit driven by a pump drive motor to supply fuel to a fuel injection unit forming a part of an internal combustion engine,
a variable fuel pressure adjustment valve that introduces the fuel to be supplied to the fuel injection unit from the fuel pump unit and is capable of adjusting to any optional one of set pressures selected from among a plurality of set pressures different in pressure from one another, and
an operation unit that operates the variable fuel pressure adjustment valve to change the one optional one of set pressures to the other one set pressure selected from among the plurality of set pressures,
the abnormality detection apparatus, comprising
a state change detection unit that operates the operation unit to change the set pressure of the variable fuel pressure adjustment valve from a first set pressure in the plurality of set pressures to a second set pressure in the plurality of set pressures when the fuel supply amount per unit time to be supplied to the fuel injection unit is maintained substantially constant, and that detects the states varied in response to an energization of the pump drive motor after the set pressure is changed, and
an abnormality determination unit that determines whether or not the change of the set pressure of the variable fuel pressure adjustment valve is in an abnormality state on the basis of a detection information detected by the state change detection unit, in which
the state change detection unit is operative to detect a variation of the state in response to the energization of the pump drive motor from the time when a signal for instructing the stop of the pump drive motor is generated to the time when the pump motor is stopped for stopping the internal combustion engine.

4. The abnormality detection apparatus for the fuel supply system as set forth in claim 3, in which
the state change detection unit is operative to detect a stopping time required to stop the pump drive motor based on the variation of either one of the electric current and the voltage, and
the abnormality determination unit is operative to determine whether an abnormality is generated for changing the set pressure of the variable pressure adjustment valve in accordance with the required stopping time detected.

5-7. (canceled)

8. The abnormality detection apparatus for the fuel supply system as set forth in claim 1, which has an electronic control unit programmed to function collectively as the state change detection unit and the abnormality determination unit.

9. The abnormality detection apparatus for the fuel supply system as set forth in claim 2, which has an electronic control unit programmed to function collectively as the state change detection unit and the abnormality determination unit.

10. The abnormality detection apparatus for the fuel supply system as set forth in claim 3, which has an electronic control unit programmed to function collectively as the state change detection unit and the abnormality determination unit.
